(19) United States
(12) Patent Application Publication
(10) Pub. No.: US 2003/0065602 A1
(43) Pub. Date: Apr. 3, 2003

(54) Methods and systems for preference-based dynamic passive investing

(76) Inventor: Kenneth Yip, New York, NY (US)

Correspondence Address: WHITE & CASE LLP, PATENT DEPARTMENT, 1155 AVENUE OF THE AMERICAS, NEW YORK, NY, 10036, US

(21) Appl. No.: 10/147,718

(22) Filed: May 16, 2002

Related U.S. Application Data
(60) Provisional application No. 60/291,474, filed on May 16, 2001.

(51) Int. Cl. G06F 17/60

(52) U.S. Cl. 705/36

(57) ABSTRACT

A method and system for dynamic, passive investment management involves selecting a number of clusters into which a plurality of selected assets are organized, investing in those clustered assets with a predefined weighting of assets within clusters and of the clusters themselves, periodically rebalancing the investments within each cluster and between the clusters, and periodically reconstituting the clusters, though not necessarily coincidentally with their rebalancing. The number of clusters is determined by the number of largest principal components sufficient to explain most of the variance of the sample covariance matrix of returns, leaving only little random variability. Correlation of asset returns within clusters is preferably comparatively high, while correlation of cluster returns is preferably comparatively low.

This application claims the benefit under 35 U.S.C ¶ 119(e) of the priority date of U.S. Provisional Patent Application No. 60/291,474 the contents of which are herein incorporated by reference in their entirety.

### FIELD OF THE INVENTION

This invention relates generally to the field of financial portfolio management and, in particular, to passive management of portfolios.

### BACKGROUND OF THE INVENTION

Conventional passive investing strategies typically employ a “buy-and-hold” strategy using capitalization-weighted indices. The buy-and-hold approach is attractive because it is a low-turnover strategy, easy to understand, and has a theoretical basis that can be traced back to Markowitz mean-variance framework and the Sharpe-Linter/Black equilibrium Capital Asset Pricing Model (CAPM) model developed in the late fifties and early sixties. Under the CAPM assumptions, an average investor should buy-and-hold the market portfolio. The prevalence of this passive strategy has given rise to a proliferation of market indexes and indexing strategies. However, the CAPM assumptions are rather restrictive. The model is static and myopic; it assumes a one-period investment horizon, which can be rather inefficient from a multi-period perspective. The CAPM assumptions require investors to have mean-variance objectives and identical investment opportunity sets. To the extent that investors have non-mean-variance preferences and non-identical investment opportunity sets, a buy-and-hold strategy might be quite sub-optimal.

Early theory regarding dynamic investment strategy suitable for long-horizon investment has been discussed by Kelly, Latané, Breiman, Hakansson, and Merton. Maximizing the mean geometric growth rate of capital was proposed as a normative criterion for rational long-horizon investing. Although the criticisms by Samuelson and Merton of the geometric mean criterion as a normative principle are valid, the criterion might still be a good approximation to the true preferences of certain investors.

Typical CAPM assumptions are much less likely to hold in international markets than in domestic ones. That is, in international markets, investor expectations are heterogeneous, goods and services are not readily-tradable from one party to another, wealth is not readily transferred, and existing world equity indices are not a good proxy for the world market portfolio.

### SUMMARY OF THE INVENTION

An investor's optimal investment policy, in an embodiment of a method according to the present invention, differs from the conventional, static, passive buy-and-hold strategy in three fundamental ways. First, the policy does not rely on the static equilibrium analysis. The policy is dynamic and multi-period. Second, the strategy is preference-based: it explicitly maximizes an investment objective—the long-term growth rate of capita I—while satisfying investor preferences and investability constraints. Third, the policy achieves significantly better temporal diversification of assets than buy and hold.

The present invention is based in part on the recognition that the multi-period investor who wishes to maximize long-term wealth and expects the returns to be independent over time and identically distributed over time should employ a strategy of constant rebalancing of clusters of assets. Rebalancing strategies in the past have not produced sufficiently consistent performance to be of significant interest. The present invention provides an approach for determining a portfolio composition of a rebalancing portfolio by fixing the weights and selecting the optimal clustering of assets for the given weights to maximize the excess growth rate of the portfolio over that of the buy-and-hold strategy subject to investability constraints. One embodiment of an investment strategy according to the present invention, e.g., for a world portfolio, employs constant rebalancing of equally weighted clusters of investable assets such as stocks. The clustering approach according to an aspect of the present invention aggregates stocks, or any basic investable unit, into clusters, the number of which is determined on the basis of the behavior of the assets. The clusters are rebalanced to maximize the portfolio growth rate while satisfying liquidity and other investment constraints. This new investment method exploits the inefficiencies of capitalization-weighted benchmarks by providing better temporal diversification than the buy-and-hold strategy.

To implement a constant rebalancing strategy, one has to determine target weights for the portfolio. In the past, the portfolio weights were either simply set to be equal or were computed by the Merton ratio using empirically estimated expected returns and covariances. Neither method is satisfactory. The equally weighted method is often too risky and produces portfolios that load up on small capitalization assets. The empirical method using expected returns is subject to large estimation risk, resulting in portfolios with extreme weights. The present invention, by contrast, makes use of historical data to estimate the covariance and correlation matrices, but does not estimate expected returns.

Once the number of clusters has been determined, the makeup of the clusters is selected in such a way that the assets within each cluster have a comparatively high degree of correlation, while the correlation between the clusters themselves is comparatively low. In other words, correlation of assets within clusters should be substantially greater than correlation between the clusters themselves. The application of the clustering approach according to the present invention to dynamic rebalancing is responsible for superior and consistent performance of the strategy over buy-and-hold and other traditional rebalancing strategies.

The present invention is a passive method of investing and portfolio management capable of providing superior returns over prior art methods of passive investment. The rebalancing approach according to the invention utilizes equal proportions of investable units and does not require currency hedging. The investable units may be clusters of regional industry groups or individual assets selected from a universe of available assets, such as a known, regional or global market index. Examples of such indices include, without limitation, Standard & Poor's 500™, the Dow Jones Global and Regional Index™ and the Morgan Stanley Capital Inc. World lndex™ (MSCI World Index). The composition of the universe of available assets might also be proprietary to a particular service provider practicing the present invention.

An embodiment of the invention may be hosted by a service provider that maintains the method and systems of the invention, updates the information stored in memory, or provides the physical or computer facilities or space for its use by an interested party. The service provider could also periodically update the market data utilized according to a method embodying the present invention to ensure that the generated portfolios reflect recent market and financial conditions and are not outdated. A service provider may be a single entity or a plurality of entities providing services to a user.

The present invention also provides for a data processing system for electronically generating a set of optimal growth portfolios that reflect the user's investment preferences and constraints. The data processing system may comprise certain conventional hardware and software components, such as a personal computer or a mainframe running financial analysis applications, as well as software for implementing methods according to the present invention for generating an investor's optimal growth portfolio.

The present invention also provides for a computer readable medium for controlling a computer or other electronic data processing system to generate a set of optimal growth portfolios for an investor in accordance with the investor's preferences. The computer readable medium may be a floppy disk, compact disk, hard disk, or other medium, that can store computer code to instruct a computer to perform a series of actions to generate a set of portfolios in accordance with the present invention.

In accordance with an aspect of the present invention, a dynamic, passive investment management method is provided, comprising the steps of identifying a plurality of assets, dividing the assets into clusters, investing in the assets such that investment in each cluster is at a pre-selected weight and rebalancing investments between clusters to their respective pre-selected weights.

In accordance with another aspect of the present invention, a computer-implemented method for investing in assets comprises the following steps. A plurality of assets is identified, from which particular assets may be selected to form an investment portfolio. From the plurality of assets a set of investment assets is selected to form the portfolio and a plurality of data sets is accessed, each data set corresponding to a respective, selected investment asset. A number of clusters is selected, into which the selected set of investment assets is to be apportioned. Each of the set of selected assets is then assigned to one of the selected number of clusters according to a measure of the degree to which data corresponding to each investment asset are correlated with data corresponding to other of the investment assets in the portfolio. The selected assets are invested, such that the investment in the assets in each cluster corresponds to a first pre-selected weighting and the investment in the clusters correspond to a second pre-selected weighting.

Yet another aspect of the present invention, involving a computer system for investing in a portfolio of assets, provides for a method for determining a number of clusters among which the assets are assigned for the purpose of investment and rebalancing. The method comprises the following steps. A plurality of assets is identified from which a set of assets is selected to form a portfolio. A plurality of data sets is accessed, each data set corresponding to a respective selected investment asset. Then, a number of clusters is selected based on the plurality of data sets.

In a further aspect of the present invention, a method for investing in a portfolio of assets comprises the following steps. A plurality of assets is identified, as are associated return data. A correlation measure is computed, on the basis of return data associated with the assets, the correlation measure capable of being analyzed to yield a plurality of factors contributing to the correlation. The plurality of factors for the correlation measure is computed, and a number of principal components is identified based on computation of the plurality of contributing factors. Then, the identified assets are apportioned over a plurality of clusters, the number of clusters corresponding to the identified number of principal components. The assets are invested such that the investment in each of the clusters is at a pre-selected weight. Finally, the clusters are re-balanced to their pre-selected weights.

According to still another aspect of the present invention, a computer-readable medium is provided for controlling a computer to generate an investment asset portfolio selection. The computer-readable medium comprises computer readable program code means for causing the computer to identify a set of assets from which a portfolio of assets may be selected, computer readable program code means for causing the computer to access historical data corresponding to each asset in the set, and computer readable program code means for causing the computer to divide the set of assets into a plurality of clusters according to the degree to which the historical data of the assets are correlated. The computer-readable program code means thereby cause the computer to select a set of clusters of assets for investment at pre-selected weightings and for periodic rebalancing to the selected weightings.

### BRIEF DESCRIPTION OF THE DRAWINGS

FIG. 1 shows a chart depicting an embodiment of a method for managing investment assets involving clustering, rebalancing and reconstitution of the investment assets according to an aspect of the present invention.

FIG. 2 shows a flow chart for an embodiment of a method for managing investment assets involving clustering, rebalancing and reconstitution of the investment assets according to an aspect of the present invention.

FIG. 3 shows a flow chart illustrating another embodiment of a method for computing a number of asset clusters according to an aspect of the present invention.

FIGS. 4A-4C show data associated with an embodiment of three asset clusters having comparatively high correlation between assets within each cluster and comparatively low correlation between the asset clusters, illustrating an aspect of the present invention.

FIG. 5 shows a schematic diagram of hardware associated with an embodiment of a system according to the present invention.

FIG. 6 shows a graph displaying the effects of a buy-and-hold strategy compared to a rebalancing strategy according to the present invention.

FIG. 7 shows a graph displaying differences in growth of a rebalanced portfolio according to the present invention, and a buy-and-hold portfolio as a function of correlation between assets.

FIG. 8 shows a graph displaying differences in growth of a rebalanced portfolio and a buy-and-hold portfolio as a function of volatility, according to the present invention.

FIG. 9 shows a graph displaying a comparison of an equally weighted cluster portfolio, according to the present invention, compared to the MSCI World Index.

FIG. 10 shows a graph displaying example historic performance of assets, when analyzed using equal weighted clusters according to the present invention, versus the MSCI World Index for the years 1989-2000.

### DETAILED DESCRIPTION

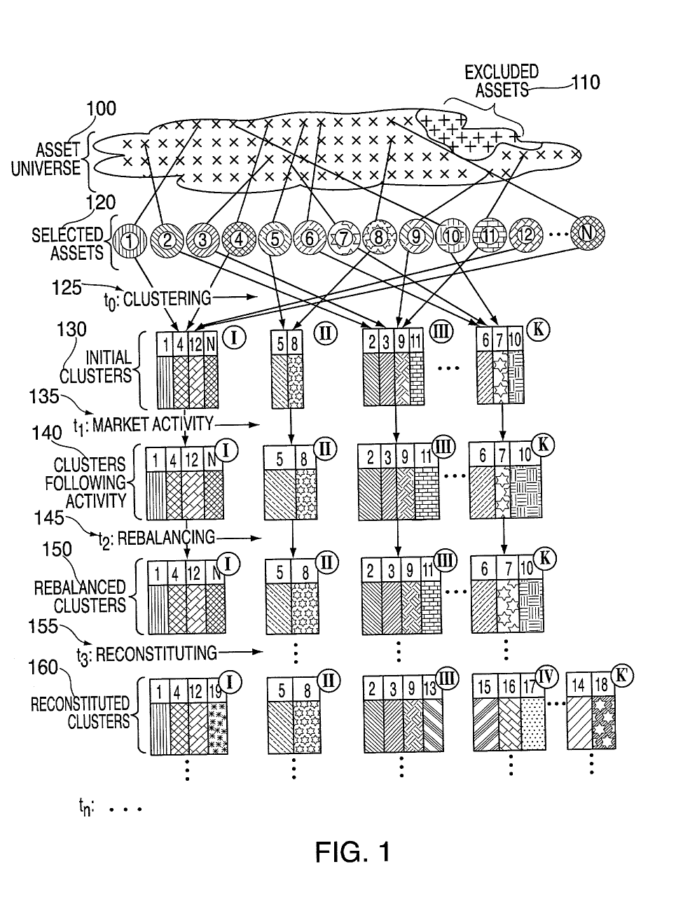

As shown schematically in FIG. 1, the present invention provides methods and systems for improved dynamic, passive management of an investment portfolio. The approach begins by identifying an asset universe 100, the constituents of which may be, for one example, assets corresponding to a traditional stock index. Other financial assets could also be the subject of the approach according to the present invention.

From asset universe 100, individual assets 120 are selected, according to investor preferences, as ones to be included in the portfolio. The other elements of asset universe 100 are excluded 110 from the portfolio for any of a variety of reasons, including investability concerns or investor preferences. Eliminating smaller assets improves investability or prevent an investor buying into assets that might have an increased risk of value loss due to insolvency or the like. Investors may also wish to avoid investing in certain assets, such as shares of stock issued by companies that market tobacco or other so-called “sin stocks.” Where the universe comprises an index, those assets whose weights in the index are below a pre-selected weight might be excluded from the plurality of assets, for example. Excluded assets 110 could include those whose weights in the index are less than 1/5N, where N is the number of assets in the index, or those in the bottom 5% of the assets in terms of the market capitalization, or those excluded according to any rule preferred by the investor.

Selected assets in clusters 120 are either individual stocks or pre-specified groups of stocks (e.g., industry sectors or regional industry groups). Examples of regional industry groups include the Americas, European countries in the European Monetary Union (EMU), European countries outside the EMU (non-EMU), and Asia. Industry groups include telecommunications, business, health care, etc., the number, types, and composition of which may vary during the time period the portfolio is held. Pre-grouping can reduce the complexity of the clustering computation at a later step by lumping together assets that are inherently correlated and proceeding with computations, described below, involving those lumped groups, rather than with a much larger number of individual assets. Such pre-grouping is not an essential or presently preferred step; rather, the individual assets themselves are preferably selected to set the number and composition of clusters. Because pre-grouping in general will involve a degree of human judgment, some investors may find it desirable to avoid the pre-grouping step, particularly where there is an interest in maximizing the degree of automation of the various aspects of the investment management approach according to the present invention. Moreover, the pre-grouping may require periodic adjustment due to changes in market condition. Avoiding this step therefore eliminates the need to attend to this adjustment. The avoidance of a pre-grouping step is facilitated by other techniques according to the present invention that render tractable the otherwise time-intensive and potentially prohibitive computation associated with clustering individual rather than grouped assets.

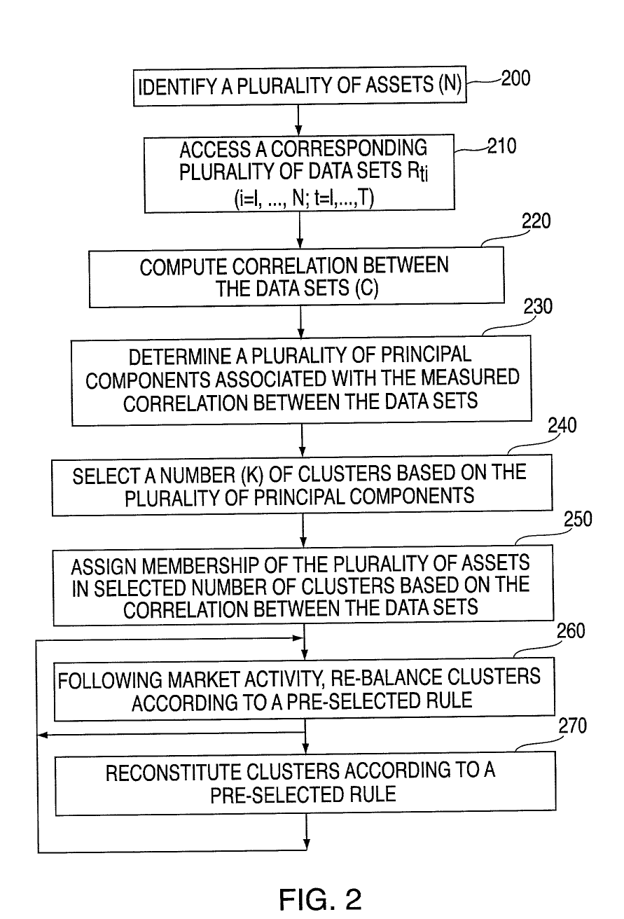

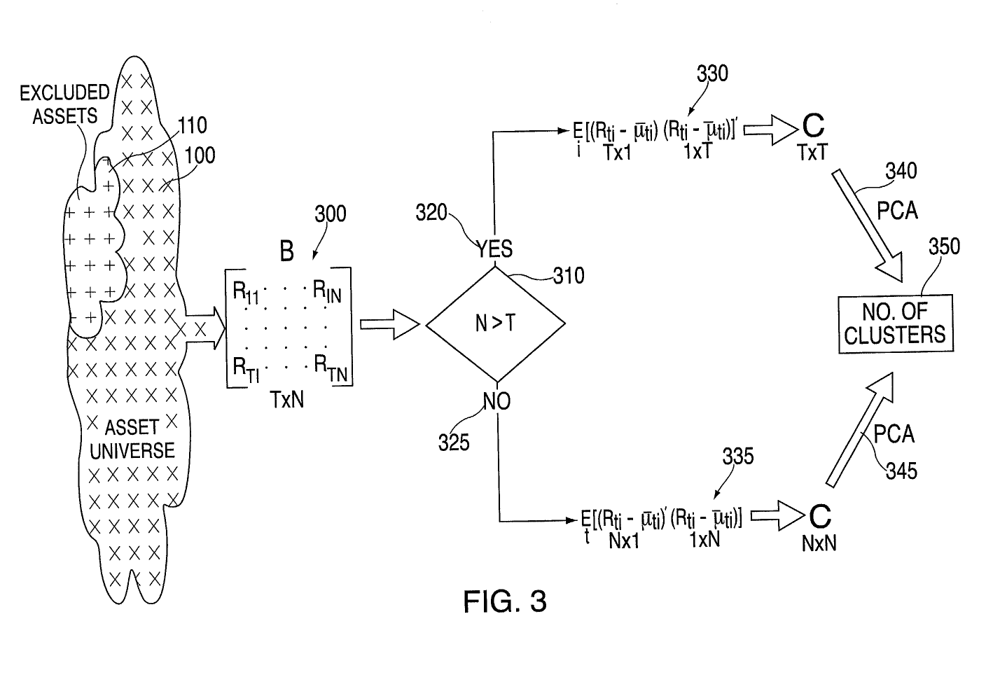

According to an aspect of the invention, selected assets 120, here shown as assets 1, . . . , 12, . . . , N, whether individual or pre-grouped, are gathered into an initial set of clusters 130 at time t₀. Clusters of assets are formed such that the behavior of assets within a cluster are comparatively highly correlated, while the correlation between clusters is comparatively low. A particular value for a number of clusters can be arrived at on the basis of a human analyst's observations of the activity in the market place. That value, however, referred to here by the variable K, is preferably determined mathematically according to another aspect of the present invention, described below with reference to FIGS. 2 and 3.

In the illustrated example K clusters are selected, of which four are shown: (I, II, III, . . . ,K), (K=4). The value of the holding of each asset in a cluster is represented by the width of a respectively hatched bar. The weight associated with each asset is represented by the proportion the hatched bar for that asset contributes to the width of the box representing the cluster. Cluster I comprises assets 1, 4, 12 and N; cluster two includes assets 5 and 8; cluster three has four assets, 2, 3, 9 and 11; and cluster K includes assets 6, 7 and 10. The clusters each include assets that are comparatively highly correlated to one another relative to the degree of correlation between clusters. Correlation between clusters is preferably between about 0.0 to 0.5, while the correlation within each cluster is preferably between about 0.5 to 1.0.

At t₀, shown at 130 for purposes of illustration, the weights of each asset within each cluster are shown in this example as being equal, while the weights of the clusters themselves is shown as differing as between the clusters. In the general case, both equal and differing initial and post-rebalancing weighting schemes can both be handled by the methods and systems according to the present invention. In a presently preferred embodiment, the weights of the clusters are set initially to equal values, to which they are re-balanced, while the weights of the assets within clusters are capitalization-weighted and are returned to capitalization-weighted values as of each re-balancing and each reconstitution. Once again, in the general case, the formation of clusters at 130 is performed such that a particular weighting within and between clusters is achieved.

Over the course of a period t₁ of market activity 135, the weighting of assets will tend to change. The weight of assets that perform well can be expected to grow at a rate that reflects their superior performance. Assets that perform poorly, on the other hand, will diminish in terms of their asset value and thus their weight. The comparative weights of the clusters themselves also are apt to vary during market activity 135.

The states of the clusters and the assets that comprise them are shown at 140. During the elapsed time t₁, assets 1, 12 and N of cluster I appear to have increased in value and therefore in weight. The value of the holdings of asset 5 in cluster II has increased markedly, the value of asset 8 less so. In cluster III, assets 2 and 9 have grown modestly, asset 11 appreciably, and asset 3 appears not to have changed. Finally, in cluster K, asset 6 grew slightly, asset 7 diminished in value, while asset 10 grew significantly in value.

At time t₂ 145, the clusters are rebalanced, leading to a set of rebalanced clusters at state 150. Rebalancing may be done on a regular basis and, if on a periodic basis, most preferably one that is at least quarterly. Rebalancing can , alternatively, be event-driven, performed whenever any asset exceeds a certain proportion or upon occurrence of any particular recurring event.

In rebalancing, the weights of the assets within each cluster, represented by their widths relative to the width of the respective cluster, are returned to their original weights, which here are equal. Rebalancing involves selling off assets to reduce the weight of those that have grown disproportionately large, and directing the proceeds to the purchase of more of those assets whose weights have fallen below their target value. Rebalancing can also be done as between clusters. In this example, which illustrates a general case in which the clusters themselves were not necessarily initially weighted equally, the rebalancing seeks to restore the relative proportions of the portfolio's total value in the clusters to reflect their initial weighting. The illustrated weights within and between clusters merely provide a non-limiting example. The weights could just as easily have been set initially to be equal both within and between clusters, which would involve period rebalancing to restore such equal weighting.

As described above, rebalancing is preferably done on a regular basis, preferably, although without limitation, at least quarterly. Because the correlation of the assets may tend to vary over time, the present invention further contemplates that the clusters be periodically reconstituted 155. Reconstitution at time t₃ 155, preferably conducted at least on an annual basis, involves the same process of identifying N selected assets consistent with investor preferences for the given portfolio. On reconstitution, the weights of assets within clusters and of the clusters themselves should be set to their desired levels, to which the weights should be re-adjusted upon the next rebalancing. The assets following reconstitution may be identical to those in the portfolio prior to reconstitution or may include new assets corresponding to current investor preferences for the portfolio and the nature of the asset universe 100. The selected assets 120 also may now exclude previously held assets that either no longer exist or no longer correspond to the preferences for the portfolio. New clusters can be formed at the time of reconstitution t₃. New assets may enter and old assets may leave during reconstitution. In the illustrated example, about 25% of the cluster membership is changed during the reconstitution.

A set of reconstituted clusters 160 includes K′ clusters, where K′ is, in this example, greater than it was prior to reconstitution. Compared with state 150, the make up of the clusters has also changed. Cluster I, which formerly comprised assets 1, 4, 12 and N, at 160 comprises assets 1, 4, 12, and 9. Cluster II remains unchanged. In cluster III, asset 11 has been replaced by asset 13. Previously hidden cluster IV, now visible, contains assets 15, 16 and 17, while new cluster K′ includes assets 14 and 18.

In general, the value of the total number of assets, N, the number of clusters K, and the number of assets within each cluster may change upon reconstitution. Once the assets are selected, the number of clusters, K, is again computed (which may be performed according to another aspect of the present invention, described below). The result of the computation during reconstitution may lead to a value K′ that differs from its previous value, K. The steps of selecting assets, identifying the number of clusters into which the assets are to be apportioned, constituting the identified number of clusters of those assets, investing in those assets and holding them during market activity, periodically rebalancing the holdings of those assets, then reconstituting those assets, can be iterated as long as the portfolio continues to be held and managed.

Optimal weights (w*) of two assets in a portfolio may be described by the following equations, wherein γᵢ(i=1,2) are the growth rates, σᵢ²(i=1,2) are the variances of the two assets and the p is the correlation between the two assets' returns over time:

$${w}^{*} = ( \frac{1}{2} + \frac{{γ}_{1} - {γ}_{2}}{J} , \frac{1}{2} + \frac{{γ}_{2} - {γ}_{1}}{J} )$$

J=σ₁²σ₂²−2ρσ₁σ₂

An equally weighted portfolio has a higher growth rate than that of the buy-and-hold portfolio if the difference in growth rates of the assets is small and the variances are large:

$${γ}_{EW} - {γ}_{BH} = - \frac{1}{2} ( {γ}_{1} - {γ}_{2} ) + \frac{1}{8} ( {σ}_{1}^{2} + {σ}_{2}^{2} - 2 {ρσ}_{1} {σ}_{2} )$$

The above equations of optimal weights and difference in growth rates between an equally weighted portfolio and a buy-and-hold portfolio can be generalized to arbitrary numbers of assets. The excess growth rate of the rebalanced portfolio over the passive buy and hold portfolio for N assets is given by:

$${γ}_{EW} - {γ}_{BH} = ( \overline{μ} - {μ}_{1} ) + \frac{1}{2} ( {σ}_{1}^{2} - \frac{1}{{N}^{2}} {\sum }_{i , j = 1}^{N} {σ}_{ij} )$$

where μ₁,σ₁² are the expected mean return and the variance of the asset with the highest growth rate.

In the steps set forth above, investor preferences and constraints can also be incorporated into the cluster construction. The investor can specify the investable universe and the position limits, for example, as well as any benchmark and a level of error tracking relative to that benchmark.

An embodiment of a method for selecting a value for the number of clusters, K, according to the present invention, is shown in FIG. 2. This aspect of the present invention is believed to lead to an optimal number of clusters that, when used with the clustering and rebalancing method described with reference to FIG. 1, leads to improved performance of that method. As shown in FIG. 2, a plurality of assets (N) is identified at 200 that form a portfolio. The identification of the assets can also exclude certain assets, as described above. For each of the identified assets, a corresponding data set is identified and accessed at 210. The data sets preferably provide historical data Rₜᵢ, t=1, . . . ,T; i=1, . . . ,N, where T is the total number of data points over time and N the number of assets.

Data Rₜᵢ relate to the performance (for example, returns) associated with the respective assets on a daily, weekly, monthly or other periodic basis. At 220, correlation measures (C) between the data sets are computed. The correlation measures serve as a basis for determining, at 230, a plurality of principal components or factors associated with the behavior of the measures. These principal components or factors may be determined according to principal component analysis, a known analytical technique. Principal component analysis is described in various source materials, including Methods of Multivariate Analysis, by Alvin C. Rencher, Wiley (1995), the contents of which are herein incorporated by reference in their entirety. The reader is directed particularly to chapter 12 of that text. Existing commercial software or custom software can be used to compute the principal components, including software available from SPLUS®, SAS®, and MATLAB®, which can operate on a matrix such as a covariance matrix and produce a number of eigenvectors or principal components.

Principal components or eigenvectors associated with the covariance matrix are attributable in part to randomness in the matrix data. This randomness, and the principal components attributable to it, can be appreciably reduced to yield improved results for the principal component analysis. In an embodiment of an aspect of the present invention, the effect of randomness in the asset data is filtered out by generating matrices having dimensions equal to those of the asset covariance matrix, but which contain random data. A number of such random matrices are generated, their values averaged and the resulting eigenvectors or principal components generated. The resulting principal components can be superposed on the principal component analysis results for the actual asset data. The principal components of interest, in this embodiment, are those that are not already accounted for in the random data matrix. The resulting number of principal components provides a basis for selecting a number of clusters into which the identified plurality of assets are apportioned. Other ways to eliminate the principal components due to randomness in the data could also be used.

In a presently preferred embodiment, the number of clusters (K) is set equal, at 240, to the number of principal components determined at 230. Membership of the N assets in the K clusters is then assigned, at 250, based on the measures of correlation C between the data sets. In the illustrated embodiment, assets that are more highly correlated with each other than with other assets are placed together in a cluster.

Following market activity, in which the value and capitalization of the portfolio assets will vary, the clusters are re-balanced, at 260, according to a pre-selected rule. In a presently preferred embodiment, but without limitation, the clusters are adjusted such that their weights in the portfolio are equal, while the weights of the assets in each cluster are adjusted so that they are capitalization-weighted at the time of the rebalancing. The rebalancing step 260 can occur as many times as required by the pre-selected rebalancing, which can be periodic, event-driven, or any other suitable rule. Also according to a pre-selected rule, the clusters are reconstituted at step 270, involving a new selection of assets, computation of the number of clusters and assignment of assets to clusters. Following re-balancing, further market activity and rebalancing, at 260, occur. The clustered assets are rebalanced and reconstituted according to the pre-selected rules for as long as the portfolio is to be managed for the investor.

The embodiment illustrated in FIG. 2 describes one general approach for computing a number of clusters into which to apportion portfolio assets according to the present invention (a more specific example of which is shown in FIG. 3) and for investing, rebalancing and reconstituting the asset clusters. The use of other suitable approaches for arriving at an advantageous number of clusters is also within the scope of the present invention.

In one embodiment, a set K of principal components driving the variance and covariance of the returns of selected assets 120 is determined. In one embodiment, a covariance matrix is computed for the plurality of N assets selected from the asset universe 100 and then a number of principal components (e.g., eigenvectors) of the correlation, or the covariance, matrix is computed. The covariance matrix is formed by first computing, as a function of the plurality of data sets, a correlation measure for each possible pairing of individual assets within the set of N selected assets. Historical data would typically comprise asset price history data. For N assets, a [T×N] history matrix can be constructed, where “T” represents the number of observations made weekly, monthly, etc., for each of the N assets. In one embodiment of the invention, two years of data is used for weekly data, and five years of data for monthly data. Choosing a preferred approach for determining the principal components, and hence a number of clusters, K, is dependent upon the histories of the number, N, of selected assets.

An example of a particular embodiment of a method for computing a number K of asset clusters is shown in FIG. 3. This aspect of the present invention provides a means for managing the computational complexity associated with identifying an optimal number of clusters. The approach involves identifying an observation matrix B, at 300, based on N selected assets and observation data 1, . . . ,T corresponding to each asset. An expectation operation, a known mathematical operation, is performed on the observation matrix B , as described further below, to yield a covariance or correlation matrix C. A set of principal components associated with matrix C is then computed by applying principal component analysis, a known mathematical technique. The number of clusters K is determined as a function of the number of largest principal components sufficient to explain most of the total variance of the sample covariance matrix, leaving only little random variability. As K is increased, the percentage of the variance explained by successive principal components tends to zero.

An aspect of the method also recognizes that the computational complexity associated with computing C depends largely on the size of the matrix upon which the expectation operator operates. If N is smaller than T, the principal components are extracted from the standard N×N sample covariance matrix. If N is larger than T, the principal components are extracted from the T×T centered cross-product expectation matrix. Connor and Korajczyk showed that as N becomes large, the principal components extracted from the T×T matrix converge to those of the sample covariance matrix up to a non-singular linear rotation.

As shown in FIG. 3, a set of N assets is selected from a universe of assets 100, some of whose elements 110 may have been excluded in advance. For each selected asset 1, . . . ,N, a set of observation data is identified and accessed. In a presently preferred embodiment, the data comprise sets of historical performance or return data Rₜᵢ, where t is the number of data in each set, from 1 to a total of T data observed at as many points in time, and where i is the number of assets, from 1 to a total of N. The data sets can be represented by N vectors of dimensionality T×1. An observation matrix B is constructed 300 in which each column comprises such a vector. Matrix B is therefore a T×N matrix, having T rows and N columns.

According to an aspect of the present invention, the approach taken for arriving at the number of clusters depends upon the size of observation matrix B in order to render the computation more tractable. If the number of assets N is greater than the number of data Rₜᵢ for each asset, as determined at 310, then branch 320 of the flowchart is taken and the following computation is performed: As shown at 330, for each column vector corresponding to an asset, a mean is computed, over time, and subtracted from each element of the vector. The vector is then multiplied by it transpose, indicated with a prime. The expectation for all such column vectors, taken over i as it ranges over all assets N, is then computed, as represented by the operator E. The result is a T×T covariance or correlation matrix C. Since T is smaller than N, computing the principal components of the resulting T×T matrix is easier than it would be for an N×N matrix. Principal component analysis (PCA), at 340, is applied to matrix C, yielding a number of principal components which, at 350, is the basis for determining a number of clusters of assets. In a presently preferred embodiment, the number of clusters is set equal to the number of most significant principal components computed at 340.

If at 310, the number of assets was found not to be greater than the number of data Rₜᵢ for each asset, then branch 325 of the flowchart is taken and the following computation is performed: As shown at 335, for each row vector corresponding to a time, a mean is computed, across assets for that point in time, and subtracted from each element of the vector. The transpose of the resulting vector is then taken, yielding an N×1 vector (indicated by a prime), which is then multiplied by the same, untransposed, 1×N vector. The expectation for all such row vectors t, as it ranges over all times T, is then computed, as represented by the operator E. The result is an N×N covariance or correlation matrix C. Since N is smaller than T, computing the principal components of the resulting N×N matrix is easier than it would be for a T×T matrix. Principal component analysis (PCA), at 345, is applied to matrix C, yielding a number of principal components which, at 350, is the basis for determining a number of clusters of assets. In a presently preferred embodiment, the number of clusters is set equal to the number of most significant principal components computed at 345.

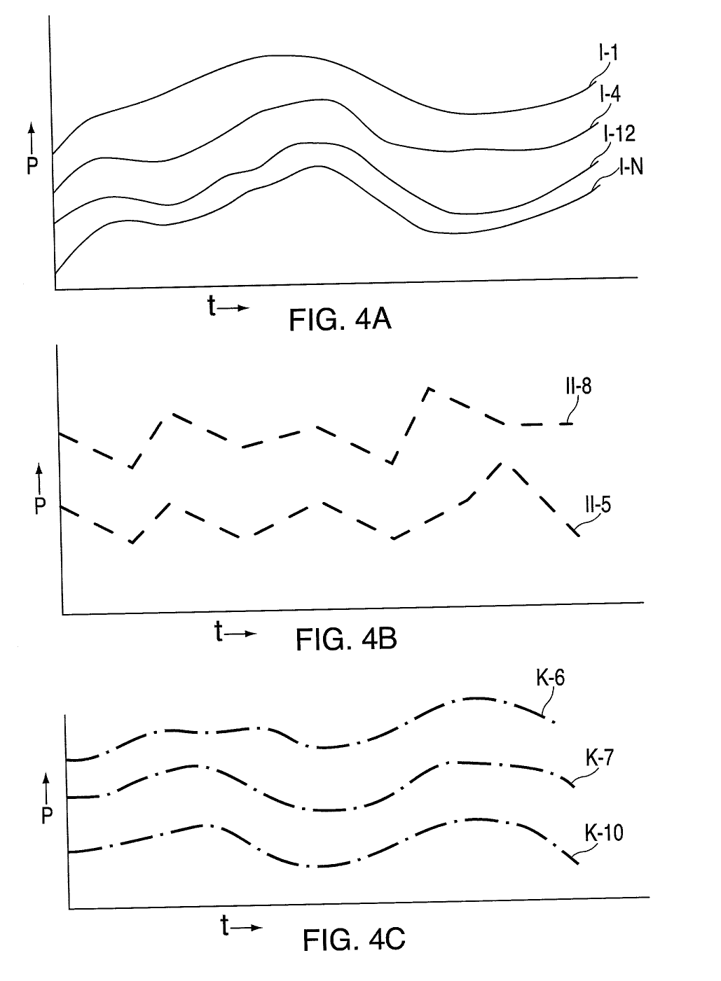

That the correlation within each cluster is preferably substantially greater than that of the correlation between clusters, according to the present invention, is illustrated in FIGS. 4A-4C. FIG. 4A shows correlation between selected assets 1, 4, 12 and N in cluster I; hence, curves I-1, I-4, I-12 and I-N. The correlation can be computed on the basis of historical data, such as pricing data, which is plotted along the y-axis. The similarity of the curves may be somewhat exaggerated for purposes of illustrating that the I-1, I-4, I-12 and I-N assets are highly correlated. Similarly, FIGS. 4B and 4C show the high correlation between sets of assets in clusters II and K, respectively. Other clusters may not be as highly correlated (close to 1.0), and the shapes not so closely related, and they can also be plotted in a similar fashion. Cluster analysis can be performed using off-the-shelf software available from such vendors as SAS™ and SPLUS™, or with suitable custom software.

In order to control exposure to country and industry risk, limits may be imposed on asset position. For example, any particular asset may not be permitted to constitute a position larger than a certain percentage of the portfolio. A rule to determine maximum and minimum deviations may be imposed on an asset in the portfolio. For example, the maximum deviation of any asset in the portfolio can be held to a level no larger than six times, nor any smaller than ⅙ of, its weight in the index. The exact level of the restriction may be varied. The excess deviation of an asset position from the cap-weight rule will be proportionately invested (or dis-invested) in the remaining assets of the portfolio according to their portfolio weights.

Investors with international holdings, denominated in currencies other than their home currency, may experience significant risks in exchange rate fluctuations. Some investors engage in hedging programs aimed at limiting the impact of significant and sudden fluctuations. Currency hedging can be used for two purposes: (1) as a pure risk reduction technique and (2) as a speculative market-timing technique to enhance return. To examine the value of volatility reduction, a preference-based decision framework for ranking various currency hedging rules may be used. Over the 1983 to 2000 time period, out-of-sample test statistics on an equally weighted and capitalization-weighted portfolio of five equity indices—United States, United Kingdom, Japan, Germany, and France—favor no hedging for investors whose objective is to maximize long-term capital growth and who do not have a view on currency premium.

Transition to an optimal growth portfolio may take several weeks, depending on the composition of the existing portfolio. Daily trading in any security may be limited, for example, to no more than 20% of the average daily trading volume. At the end of the initial transition period, there may still be some remnants of the existing portfolio to be dealt with. Transition may be started at any time, although individual preference may determine any date timeline. The exact timetable will be determined in order to optimally access all sources of liquidity available to the investor.

Benefits of the invention may be particularly evident where the present investment assets or groups of assets have low correlation and high volatility. Other implementation issues include transaction costs that arise from high turnover of assets, liquidity issues in “thin” markets, and the advantages of sector diversification.

An optimal growth portfolio may, as discussed above, be reconstituted and rebalanced periodically. For example, the portfolio may be rebalanced quarterly and reconstituted annually. Liquidity/volatility concerns may also affect reconstitution/rebalance times. For example, a manager may wish to avoid “earnings season” in the U.S., the summer vacation period in Europe, and the last half of December due to liquidity/volatility concerns. Depending on the complexity and composition of a portfolio and the volume of trading, rebalancing and reconstitution may take several days to implement.

The simplest rebalancing rule is calendar-based. Any of a variety of other approaches could also be used. For one example, involving an event-based approach, rebalancing is triggered when the weight of a cluster in the portfolio departs from a permissible range for the cluster. This approach may be referred to as “range-based” rebalancing. One can seek to identify an optimal rebalancing strategy for reducing turnover given the same amount of tracking error as compared to simple periodic rebalancing. The particular conditions under which the portfolio is being managed, however, which include the level of transaction costs associated with rebalancing, may make the gain in optimal rebalancing over a heuristic calendar-based method not sufficiently large to justify such approach. For this type of application, a simple heuristic rebalancing method may be preferable.

Practicing the methods according to the present invention may present special considerations relating to index changes and corporate actions. For example, when a stock is added to the index it needs to be purchased in proportion to its weight in the relevant investment “component”. Shares for rights issues should be taken up in proportion to ownership of the securities. Similarly, ownership would be increased proportionately when a company's shares outstanding are increased. In order to engage in these types of activities on a cost-effective basis, a small cash buffer might be maintained, which would be equitized with an appropriate futures basket of CFTC approved contracts. In general, a minimized equitized cash position will be preferred to increase overall returns.

A service provider may choose to implement any type of fee structure to recover costs associated with the claimed invention. For example, a service provider may charge an asset management fee for administration of the assets in an investor's portfolio. Alternatively, a provider may charge a performance fee instead of an asset management fee.

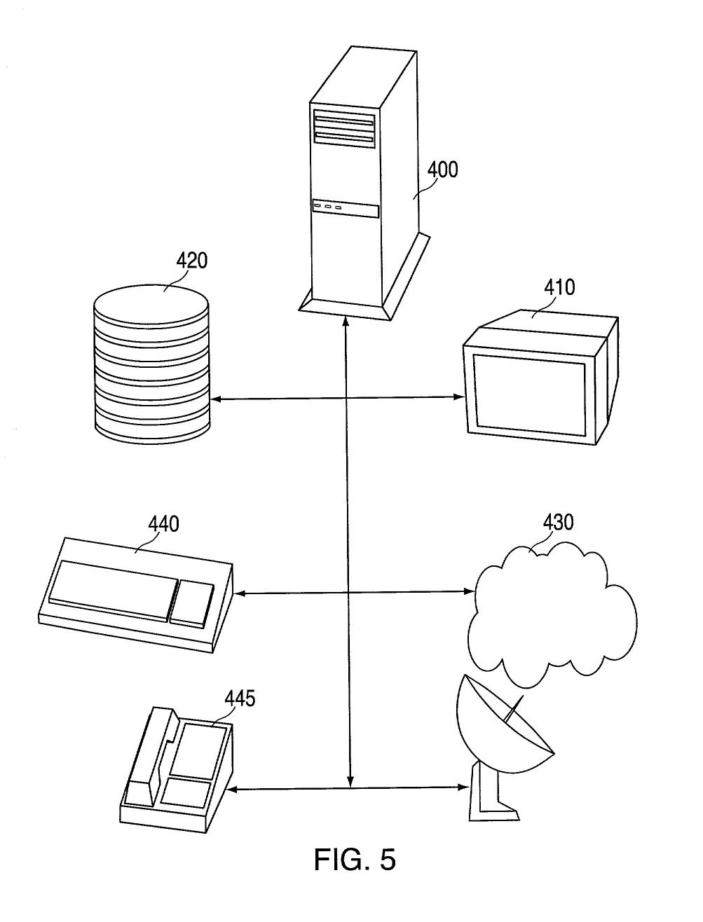

FIG. 5 is a schematic diagram of an embodiment of a system according to the present invention. The system comprises a processor 400, a display device 410, storage device 420, user input devices 440, 445. A communications medium such as a network 430 may connect the system to one or more remote systems, such as a web server or a host computer, for receiving and transmitting data and information from the other, remote, system. The price, return, and market capitalization data are downloaded from vendors (such as MSCI, CRSP, FAME) and imported into a database, such as an Oracle® database. The clustering and rebalancing routines retrieve their required inputs from the database.

The system may comprise any type of conventional computer system and operating system used in the financial services industry. In a presently preferred embodiment, processing is done on a personal computer. The computational approach shown and described with respect to FIG. 3 make it possible to handle large portfolios according to the methods of the present invention while operating on a conventional personal computer and in a practicable time frame.

The aspects of the present invention may be practiced using any suitable, conventionally available input, display and data storage devices and may also include an optional communications access device such as a modem, network interface card or port, or wireless transmitter for providing computer-to-computer communication capabilities. It may further involve a web server that would provide connectivity to a network such as an intranet, extranet, or the Internet, allowing for remote access to the software supporting the methods of the present invention. In such a case, a client system may run any suitable web browsing programs or other software that would permit a user to access the network. The system may also include additional software components that would allow a user to view data and information in a range of formats. Examples of such ancillary types of software components are image viewing programs such as Adobe Acrobat™, presentation programs such as Corel Presentations™, and analysis tools including spreadsheets such as Lotus 1-2-3™ and Microsoft Excel™. Visually impaired users may choose a program such as In Cube™ or IBM HomePageReader™ to provide access to the invention.

The instruction set that is used to direct a system to perform a function in the invention may be present as software in memory or implemented as hardware, for example by being burned onto a computer chip or integrated circuit. The instruction set may be written in C++, SAS, VisualBasic™, assembler, Borland Delphi™, Java™, Javascript™, or any other language or combination of languages selected by a service provider, coder or programmer. The instruction set may also be a macro or template in a spreadsheet, or a custom-designed and implemented application. A service provider may also choose to implement the invention as an applet within a web page.

A service provider on a publicly-accessible site, location, or web page, or on a restricted-access site may host the invention. A user may, for example, access the software by running a web browser on a client system and entering a uniform resource locator (“URL”) corresponding to the web address of a server system, which may be running a web server which then allows access to the software application.

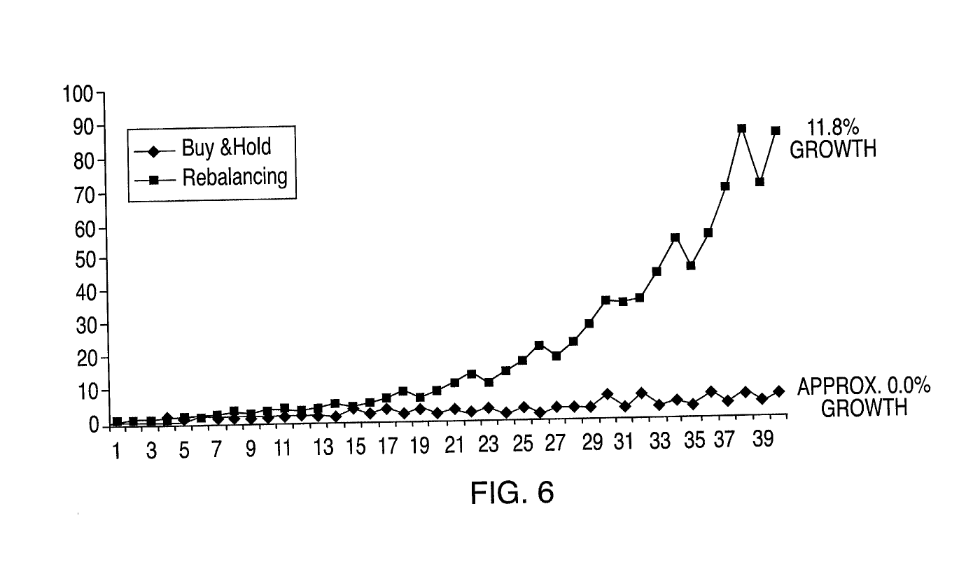

The principles and advantages of the method and system according to the present invention may be better understood further in view of the various graphs presented in FIGS. 6-10.

FIG. 6 shows a graph that compares the effects of a buy-and-hold strategy and a rebalancing strategy on a portfolio comprising two uncorrelated risky assets which either double or halve their values with equal probability at each successive period. The buy-and-hold strategy can be seen to yield essentially no growth in the wealth of the portfolio, while the rebalancing strategy yields an 11.8% growth of wealth portfolio. In this figure, 50% is invested in each asset at each period in the rebalanced portfolio.

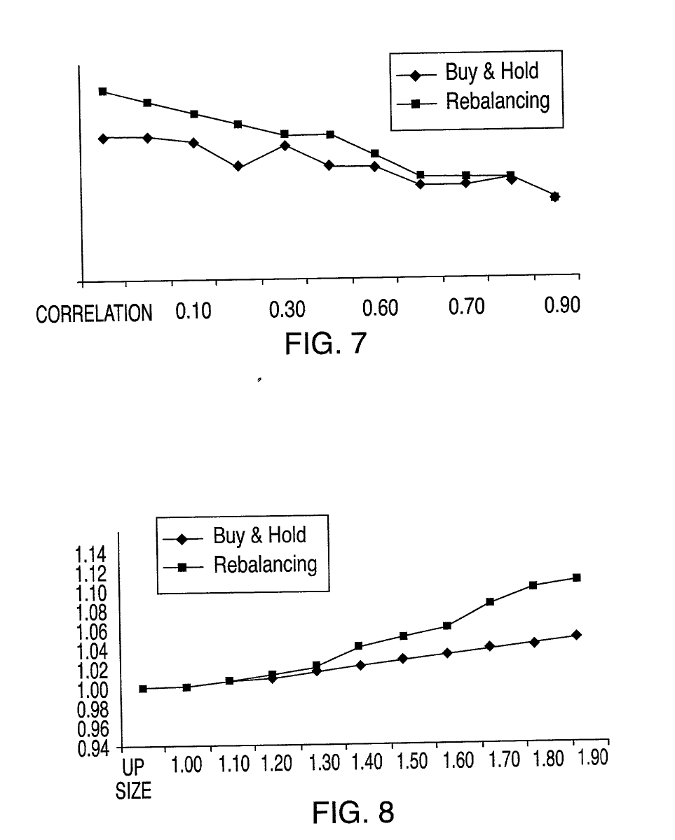

FIG. 7 shows differences in growth of a rebalanced portfolio and a buy-and-hold portfolio as a function of correlation between assets using the same assumptions as those in the graph of FIG. 6. The graph demonstrates that the lower the correlation between assets, the higher the growth of the rebalanced portfolio compared to the buy-and-hold portfolio. As assets in the portfolio are increasingly correlated, growth of the rebalanced portfolio decreases, until at high correlation levels (as the correlation approaches 1.0), the growth between the buy-and-hold portfolio and the rebalanced portfolio is essentially identical. Low correlations between assets in a rebalanced portfolio contribute to higher investor returns.

FIG. 8 shows a graph that plots differences in growth of a rebalanced portfolio and a buy-and-hold portfolio as a function of volatility using the same assumptions that are made in connection with FIG. 6. The volatility is directly related to the size of the up and down moves at successive periods. The buy-and-hold portfolio exhibits a significantly lower growth at higher volatilities than the rebalanced portfolio. The higher the volatility of the portfolio of assets, for example, above 1.35, the more advantageous a rebalancing strategy is over a buy-and-hold strategy.

Table I below shows examples of clusters, components, and securities. Clusters, in this example, encompass assets from regions of the world that an investor may wish to have represented in his or her financial portfolio. Examples of regions are Europe (EMU and non-EMU), Asia, and North America. These clusters comprise components that are preferably equally weighted. The components may represent different business sectors, such as telecommunications, pharmaceuticals, financial services, and manufacturing. Each cluster comprises a plurality of investment assets such as securities issued by firms which operate in the selected region.

TABLE I

| | | | | EMU, Non & | ASIA & Non | Americas & |
|---|---|---|---|---|---|---|
| | EMU & Non EMU | Asia | North | North | EMU | Non EMU |
| Clusters | Telecommunications | Some common | Technology | Interest rate | Interest rate | Americas |
| (equal- | and 'business’ | themes across | behaves | sensitive | sensitive raw | region |
| weighted) | common across | Asia that behave | differently | sectors in | materials | |
| | Europe | differently from | than the | tandem | markets | |
| | | balance of region | balance of | across Europe | linked | |
| | | | stocks in the | and Americas | | |
| | | | region | | | |
| Component | EMU Telecom | Asia Electronic | Americas | Americas | Asia | Americas |
| (equal- | EMU Business | Component | Electronic | Capital | Energy | Energy |
| weighted) | EMU Insurance | Asia Business | Comp. | Equipment | Asia | Americas |
| | EMU Cap.Equip. | Asia Health | Americas | Americas | Telecom | Telecom |
| | EMU Health | Asia Consumer | Business | Materials | Asia | Americas |
| | EMU Multi- | Goods | Americas | EMU Energy | Financial | Financials |
| | Industry | | Multi- | EMU | Asia | Americas |
| | EMU Services | | industry | Financial | Insurance | Insurance |
| | Non EMU | | Americas | EMU | Asia | Americas |
| | Telecom | | Services | Consumer | Health | Health |
| | Non EMU | | | Goods | Asia | Americas |
| | Business | | | EMU | Materials | Consumer |
| | | | | Materials | Asia Multi | Goods |
| | | | | Non EMU | Industry | Non EMU |
| | | | | Electronic | Asia | Health |
| | | | | Componen | Services | |
| | | | | Non EMU | Non EMU | |
| | | | | Financial | Energy | |
| | | | | Non EMU | Non EMU | |
| | | | | Insurance | Materials | |
| | | | | Non EMU | | |
| | | | | Capital | | |
| | | | | Equipment | | |
| Securities | Examples | Examples | Examples | Examples | Examples | Examples |
| (cap- | British Telecom | Sony | Adobe | Bethlehem | Nippon | Bell South |
| weighted) | Alcatel | Canon | Systems | Steel | Japan | Citigroup |
| | Schering | Chartered Semi- | Cisco | AXA | Energy | Wal-Mart |
| | | conductor | Applied | MSBC | Hang Sang | |
| | | | Materials | Holdings | Bank | |

For example, British Telecom and Alcatel may be selected as components of the European region, since these firms operate in Europe. These examples are presented for illustration only, and investors or service providers may choose any particular grouping of countries, regions, or securities which they feel best reflects their investment goals and style of investment.

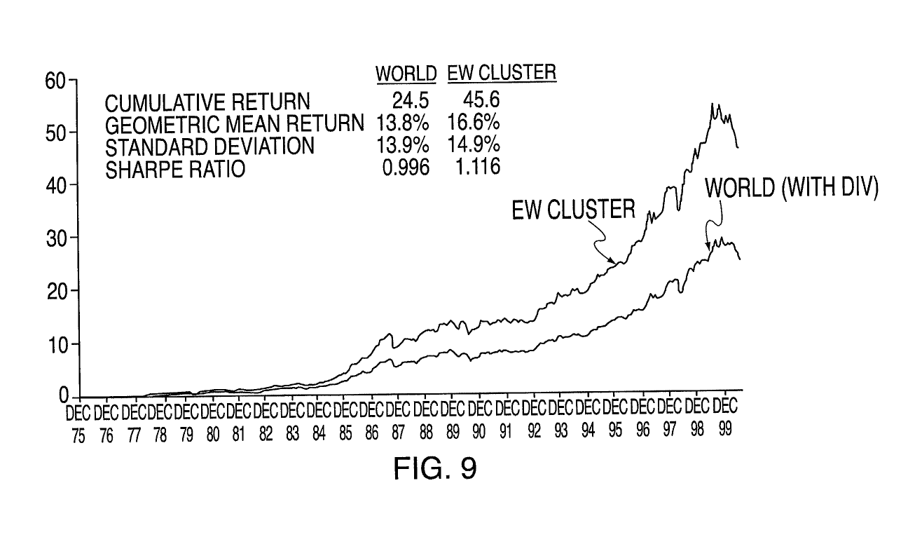

FIG. 9 shows a graph displaying a comparison of an equally weighted (EW) cluster portfolio compared to the MSCI World Index (World Index) from 1/1977 to 9/2001. The geometric mean returns are also higher for the cluster portfolio, 16.13% compared to 13% for the World Index. The underlying data is seen more clearly in Table II, below.

The advantages of the present invention in not requiring the forecasting of capital market conditions are illustrated in Table II. The empirical results shown in the Table demonstrate that an embodiment of the method according to the present invention, when applied to historical data, consistently outperforms the MSCI Developed Market World Index from 1977 to 2000. The average annual excess return resulting from an application of an embodiment of the present invention over the world index (with dividends) is 200 basis points. The present method outperforms the World Index in all five 5-year sub-periods. The added economic value is believed to come from volatility diversification over time. The application of the present invention is therefore well-diversified in country and industry exposures and satisfies liquidity constraints. The composition of the universe of assets is independent of the investor's home country.

TABLE II

| | Annualized | | EW | | |
|---|---|---|---|---|---|
| | EW Cluster | Annualized | Standard | World | Turn over |
| Year | Return | World Return | Deviation | Standard | quarter |
| 1976 | 15.39% | 14.71% | 17.39% | 12.81% | 4.34% |
| 1977 | 17.47% | 2.00% | 7.14% | 6.69% | 10.42% |
| 1978 | 25.64% | 18.22% | 12.41% | 11.29% | 4.92% |
| 1979 | 7.76% | 12.67% | 13.27% | 11.56% | 11.78% |
| 1980 | 25.00% | 27.72% | 15.72% | 16.37% | 3.65% |
| 1981 | −0.19% | −3.30% | 15.95% | 13.06% | 13.02% |
| 1982 | 8.84% | 11.27% | 13.01% | 16.10% | 4.63% |
| 1983 | 21.33% | 23.28% | 8.96% | 8.45% | 9.77% |
| 1984 | 9.33% | 5.77% | 16.72% | 14.72% | 9.17% |
| 1985 | 57.57% | 41.77% | 8.58% | 7.89% | 15.08% |
| 1986 | 62.35% | 42.80% | 15.70% | 15.05% | 7.80% |
| 1987 | 18.04% | 16.76% | 26.95% | 24.47% | 8.80% |
| 1988 | 24.21% | 23.95% | 12.57% | 11.57% | 3.81% |
| 1989 | 18.00% | 17.19% | 15.66% | 14.10% | 8.29% |
| 1990 | −12.60% | −16.52% | 23.23% | 22.48% | 10.30% |
| 1991 | 15.06% | 18.97% | 17.70% | 15.75% | 5.03% |
| 1992 | −4.60% | −4.66% | 11.77% | 8.98% | 10.85% |
| 1993 | 27.08% | 23.13% | 10.36% | 11.49% | 9.45% |
| 1994 | 7.08% | 5.58% | 13.34% | 11.35% | 7.45% |
| 1995 | 20.73% | 21.32% | 9.31% | 8.74% | 11.69% |
| 1996 | 18.73% | 14.00% | 8.14% | 8.17% | 8.07% |
| 1997 | 20.41% | 16.23% | 14.45% | 14.29% | 11.32% |
| 1998 | 24.67% | 24.80% | 19.68% | 19.64% | 13.66% |
| 1999 | 28.85% | 25.34% | 12.71% | 12.19% | 13.64% |
| 2000 | −16.97% | −15.51% | 14.37% | 14.84% | 5.13% |

Table III below demonstrates the effect of variance reduction when comparing buy-and-hold and rebalanced financial portfolios. Accumulated values and consequent annual returns are clearly seen to be higher for the rebalanced clustered portfolio as compared to the buy-and-hold portfolio.

TABLE III

| Accumulated Value | | Annual Returns | |
|---|---|---|---|
| Buy & | | Buy & | |
| Hold | Rebalancing | Hold | Rebalancing |
| 1.0000 | 1.0000 | | |
| 1.2500 | 1.2500 | 25.00% | 25.00% |
| 1.0000 | 1.5625 | −20.00% | 25.00% |
| 1.2500 | 1.2500 | 25.00% | −20.00% |
| 2.0313 | 1.5625 | 62.50% | 25.00% |
| 1.2500 | 1.9531 | −38.46% | 25.00% |
| 2.5000 | 2.4707 | 100.00% | 26.50% |
| 2.0000 | 1.9766 | −20.00% | −20.00% |
| 2.1250 | 2.4707 | 6.25% | 25.00% |
| 2.0000 | 3.0518 | −5.88% | 23.52% |
| 2.0313 | 3.8147 | 1.56% | 25.00% |
| 1.2500 | 3.0884 | −38.46% | −19.04% |
| 2.0781 | 3.8147 | 66.25% | 23.52% |
| 1.2500 | 4.7125 | −39.85% | 23.54% |
| 2.1250 | 5.9605 | 70.00% | 26.48% |
| 2.0000 | 4.8256 | 5.88% | −19.04% |
| 2.1250 | 5.9605 | 6.25% | 23.52% |
| 4.0079 | 7.4506 | 88.61% | 25.00% |
| 2.3125 | 5.9605 | −42.30% | −20.00% |
| 4.0156 | 7.3633 | 73.65% | 23.54% |
| 2.1250 | 9.0949 | −47.08% | 23.52% |

| | | |
|---|---|---|
| Geometric mean | 3.84% | 11.67% |
| Arithmetic mean | 13.36% | 13.65% |
| Standard deviation | 47.90% | 19.70% |

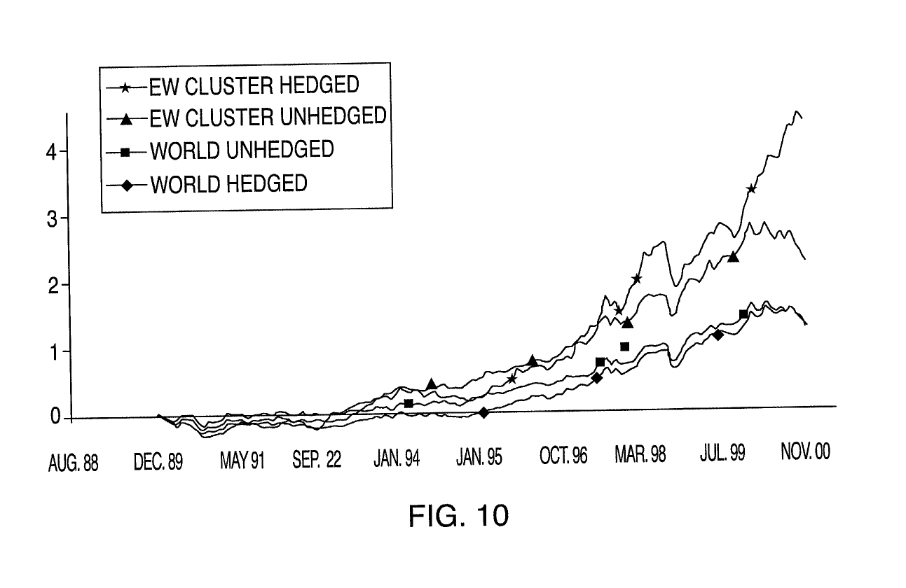

FIG. 10 shows the effects of hedging on an equally weighted cluster compared to the MSCI World Index (excluding dividends) over the time period from 1989-2001. Hedging can be seen to reduce returns of a portfolio, whether the portfolio is clustered or the Index Fund. The highest returns are obtained for the equally weighted clustered portfolio without hedging. Even when hedging is included, the returns of the clustered portfolio are higher than the Index Fund hedged and unhedged portfolios.

In addition to the embodiments of aspects of the present invention described above, those of skill in the art will be able to arrive at a variety of other arrangements and steps which, if not explicitly described in this document, nevertheless embody the principles of the invention and fall within the scope of the appended claims.

What is claimed is:

1. A dynamic, passive investment management method comprising the steps of:
identifying a plurality of assets;
dividing the assets into clusters;
investing in the assets such that investment in each cluster is at a pre-selected weight; and
rebalancing investments between clusters to their respective pre-selected weights.

2. The method according to claim 1, wherein the rebalancing is performed on at least a quarterly basis.

3. The method according to claim 1, wherein the rebalancing is performed on an event-driven basis.

4. The method according to claim 3, wherein the rebalancing is range-based.

5. The method according to claim 1, wherein an asset whose weight among the identified plurality of assets is below a pre-selected weight threshold is excluded from the identified plurality of assets.

6. The method according to claim 1, wherein an asset is excluded from the identified plurality of assets based upon an investability constraint.

7. The method according to claim 1, wherein an asset is excluded from the identified plurality of assets based upon an investor preference to avoid investing in an asset of a particular kind.

8. The method according to claim 1, wherein the degree of correlation between clusters is lower than the degree of correlation between assets in each cluster.

9. The method according to claim 4, wherein the correlation between clusters is between about 0.0 and 0.5.

10.The method according to claim 4, wherein the correlation of assets within clusters is between about 0.5 and 1.0.

11. The method according to claim 1, wherein each of the plurality of clusters comprises assets selected only from a corresponding industry group.

12. The method according to claim 1, wherein the pre-selected weighting of clusters comprises an equal weighting.

13. The method according to claim 1, wherein the pre-selected weighting of clusters comprises an unequal weighting

14. The method according to claim 1, wherein the holdings of assets within a cluster are according to a pre-selected weighting, to which the asset holdings are rebalanced from time to time.

15. The method according to claim 14, wherein the pre-selected asset weighting within the cluster comprises an equal weighting.

16. The method according to claim 14, wherein the pre-selected asset weighting within the cluster comprises a capitalization weighting.

17. The method according to claim 1, wherein the set of assets is represented in an index.

18. The method according to claim 1, further comprising the step, prior to dividing the assets into clusters, of selecting a number of clusters into which the selected assets are to be divided.

19. The method according to claim 18, wherein the number of clusters is selected on the basis of historical data associated with the selected assets.

20. The method according to claim 19, wherein the number of clusters is selected on the basis of the correlation of data representing asset returns.

21. The method according to claim 1, wherein the clusters are reconstituted from time to time.

22. The method according to claim 21, wherein the clusters are reconstituted according to a calendar-based approach.

23. The method according to claim 22, wherein the clusters are reconstituted according to an event-based approach.

24. The method according to claim 19, wherein the clusters are reconstituted from time to time.

25. The method according to claim 24, wherein the clusters are reconstituted according to a calendar-based approach.

26. The method according to claim 24, wherein the clusters are reconstituted according to an event-based approach.

27. A computer-implemented method for investing in assets comprising the steps of:
identifying a plurality of assets from which particular assets may be selected to form an investment portfolio;
selecting from the plurality of assets a set of investment assets to form the portfolio;
accessing a plurality of data sets, each data set corresponding to a respective, selected investment asset;
selecting a number of clusters into which the selected set of investment assets is to be apportioned;
assigning each of the set of selected assets to one of the selected number of clusters according to a measure of a degree to which data corresponding to each investment asset are correlated with data corresponding to other of the investment assets in the portfolio; and
investing in the selected assets such that the investment in the assets in each cluster correspond to a first pre-selected weighting and the investment in the clusters correspond to a second pre-selected weighting.

28. The method according to claim 27, further comprising the step of rebalancing investments in at least one of the group consisting of the clusters and the assets within the clusters.

29.The method according to claim 28, wherein the rebalancing comprises rebalancing of the assets in each cluster to their respective pre-selected weighting.

30. The method according to claim 28, wherein the rebalancing comprises rebalancing the investments among the clusters to their respective pre-selected weighting.

31. The method according to claim 27, wherein the first pre-selected weighting of assets in a cluster comprises capitalization weighting.

32. The method according to claim 27, wherein the first, pre-selected weighting of assets in a cluster comprises an equal weighting.

33. The method according to claim 27, wherein the second pre-selected weighting of clusters in the portfolio comprises an equal weighting.

34. The method according to claim 27, wherein the second pre-selected weighting of clusters in the portfolio comprises an unequal weighting.

35. The method according to claim 34, wherein the second pre-selected weighting of clusters in the portfolio comprises a capitalization weighting.

36. The method according to claim 27, wherein the plurality of assets is represented in an index, and those assets whose weights in the index are below a pre-selected weight are excluded from the portfolio.

37. The method according to claim 27, wherein each data set comprises historical data associated with the individual selected asset.

38. The method according to claim 37, wherein the historical data comprises price history data for the individual assets.

39. The method according to claim 27, wherein correlation between clusters is lower than correlation between assets in each cluster.

40. The method according to claim 39, wherein the correlation between clusters is between about 0.0 to 0.5.

41. The method according to claim 39, wherein the correlation within each cluster is between about 0.5 to 1.0.

42. The method according to claim 27, wherein each of the plurality of clusters comprises assets selected only from a corresponding regional industry group.

43. The method according to claim 27, wherein the pre-selected weighting investment in each of the plurality of clusters is equally weighted.

44. The method according to claim 27, wherein the step of rebalancing is performed on at least a quarterly basis.

45. The method according to claim 28, wherein the step of rebalancing is performed on an event-driven basis.

46. The method according to claim 29, wherein the rebalancing within clusters is performed on a calendar-driven basis.

47. The method according to claim 29, wherein the rebalancing within clusters is performed on an event-driven basis.

48. The method according to claim 30, wherein the rebalancing between clusters is performed on a calendar-driven basis.

49. The method according to claim 30, wherein the rebalancing between clusters is performed on an event-driven basis.

50. The method according to claim 27, further comprising the step of reconstituting the clusters of the portfolio.

51. The method according to claim 27 wherein the step of reconstituting the portfolio is performed on at least an annual basis.

52. In a computer system for investing in a portfolio of assets, a method for determining a number of clusters among which the assets are assigned for the purpose of investment and rebalancing, the method comprising the steps of:
identifying a plurality of assets from which a set of assets is selected to form a portfolio;
accessing a plurality of data sets, each data set corresponding to a respective selected investment asset; and
selecting a number of clusters based on the plurality of data sets.

53. The method according to claim 52, wherein a correlation measure is computed, as a function of the plurality of data sets, of the degree to which each data set is correlated with others of the plurality of data sets and wherein the selection of the number of clusters is based on the computed correlation measures associated with the data sets.

54. The method according to claim 53, wherein a plurality of principal components is determined for the correlation measures associated with the data sets, and the selection of the number of clusters is based on the determination of principal components of the correlation measures associated with the data sets.

55. The method according to claim 54, further comprising the step of forming a correlation matrix based on the computed correlation measures, the correlation matrix providing the basis for the computation of the principal components.

56. The method according to claim 55, wherein the correlation matrix comprises a covariance matrix;

57. The method according to claim 52, wherein the investment assets among the plurality of clusters are apportioned according to the degree to which the data corresponding to each asset are correlated with the data corresponding to the other assets in the portfolio.

58. The method according to claim 52, wherein each data set comprises historical data associated with an individual asset.

59. The method according to claim 58, wherein the historical data comprises price data.

60. A method for investing in a portfolio of assets, the method comprising the steps of:
identifying a plurality of assets and associated return data; computing a correlation measure based on the return data associated with the assets, wherein the correlation measure is capable of being analyzed to yield a plurality of factors contributing to the correlation;
computing the plurality of factors for the correlation measure;
identifying a number of principal components based on computation of the plurality of contributing factors;
apportioning the assets over a plurality of clusters, the number of clusters corresponding to the identified number of principal components;
investing in the assets, so that the investment in each of the clusters is at a pre-selected weight; and
rebalancing the clusters to their pre-selected weights.

61. The method according to claim 60, wherein the correlation measure comprises a covariance matrix.

62. The method according to claim 60, wherein the principal components relate to the correlation of the returns of the selected assets.

63. The method according to claim 60, wherein the pre-selected weight of the investment assets in the plurality of clusters comprises an equal weighting.

64. The method according to claim 60, wherein the pre-selected weight of the investment assets within each cluster comprises a capitalization weighting.

65. The method according to claim 60, wherein rebalancing of the clusters is performed on a calendar basis.

66. The method according to claim 65, wherein the rebalancing of the clusters is performed on at least a quarterly basis.

67. The method according to claim 60, wherein the rebalancing of the clusters is performed on an event-driven basis.

68. The method according to claim 67, wherein the rebalancing is range-based.

69. The method according to claim 60, wherein an asset whose weight among the identified plurality of assets is below a pre-selected weight threshold is excluded from the identified plurality of assets.

70. The method according to claim 60, wherein an asset is excluded from the identified plurality of assets based upon an investability constraint.

71. The method according to claim 60, wherein an asset is excluded from the identified plurality of assets based upon an investor preference to avoid investing in an asset of a particular kind.

72. The method according to claim 60, wherein the degree of correlation between clusters is lower than the degree of correlation between assets in a cluster.

73. The method according to claim 60, wherein each of the plurality clusters comprises assets selected only from a corresponding industry group.

74. A computer-readable medium for controlling a computer to generate an investment asset portfolio selection, the computer-readable program means comprising:
computer readable program code means for causing the computer to identify a set of assets from which a portfolio of assets may be selected;
computer readable program code means for causing the computer to access historical data corresponding to each asset in the set; and
computer readable program code means for causing the computer to divide the set of assets into a plurality of clusters according to the degree to which the historical data of the assets are correlated;
whereby the computer-readable medium causes the computer to select a set of clusters of assets for investment at pre-selected weightings and for periodic rebalancing to the selected weightings.

75. The computer-readable medium according to claim 74, wherein the set of assets comprises assets selected only from a corresponding regional industry group.

76.The computer-readable medium according to claim 74, wherein the number of clusters is selected on the basis of an analysis of principal components contributing to correlation between the historical return for the assets.

77. The computer-readable medium according to claim 74, wherein the number of clusters is between about 6 and 8 for assets listed among MSCI regional sectors.

78. The computer-readable medium according to claim 74, wherein the number of clusters is between about 15 and 20 for assets listed among the SP500.

79. The computer-readable medium according to claim 74, wherein the historical data comprises price history data for the individual assets.

80. The computer-readable medium according to claim 74, wherein the degree of correlation between clusters is lower than the degree of correlation between assets in each cluster.

81. The computer-readable medium according to claim 80, wherein the correlation between clusters is between about 0.0 to 0.5.

82. The computer-readable medium according to claim 80, wherein the correlation within each cluster is between about 0.5 to 1.0.

83. The computer-readable medium according to claim 74, wherein the clusters are equal-weighted.

84. The computer-readable medium according to claim 74, wherein the investment assets within each cluster are capitalization-weighted.

85. The computer-readable medium according to claim 74, wherein the clusters are rebalanced on at least a quarterly basis.
